(19) United States
(12) Patent Application Publication
(10) Pub. No.: US 2013/0110268 A1
(43) Pub. Date: May 2, 2013

(54) CONTENT PLAYBACK DEVICE, CONTENT PLAYBACK METHOD, AND CONTENT PLAYBACK PROGRAM

(71) Applicants: Masaki Matsuura, Kanagawa (JP); Katsunao Takahashi, Kanagawa (JP)

(72) Inventors: Masaki Matsuura, Kanagawa (JP); Katsunao Takahashi, Kanagawa (JP)

(73) Assignee: PANASONIC CORPORATION, Osaka (JP)

(21) Appl. No.: 13/808,068

(22) PCT Filed: May 12, 2011
(86) PCT No.: PCT/JP2011/002655

§ 371 Date: Jan. 2, 2013

(30) Foreign Application Priority Data
Jul. 5, 2010 (JP) 2010-152626

(51) Int. Cl. G06F 17/00

(52) U.S. Cl. CPC G06F 17/00
USPC 700/94

(57) ABSTRACT

Provided is a content playback device which can set easily and definitely the repetition number of a predetermined content by user gestures. A content playback device capable of playing a content a number of times, includes: an input means which receives a user's operation; a repetition number deciding means which decides the number of plays based on a locus of contact operation received by the input means; and a playback means which plays the content based on the number of times which is decided by the repetition number deciding means.

### TECHNICAL FIELD

This invention relates to a content playback device, a content playback method, and a content playback program.

### BACKGROUND ART

Conventionally, it is known that when a content is played, the same content is repeatedly played.

A technique for easy track skip operation even when size of a music player is reduced without providing a dedicated track skip button (for example, see Patent Document 1). Further, a touch type character input device which determines a character based on the number of turns is proposed (for example, see Patent Document 2).

### RELATED ART DOCUMENTS

### Patent Documents

Patent Document 1: JP-A-2008-181367
Patent Document 2: JP-A-2008-269456

### SUMMARY OF THE INVENTION

### Problem to be Solved by the Invention

However, in Patent Document 1, there are problems that it is impossible to simultaneously perform both a skip operation and a repetition setting operation or to set the repetition number of a content except the content that is being played.

In Patent Document 2, there are problems that it is difficult to detect the number of turns when a slide which is not a straight line is performed, whereby an unexpected number of times may be set. When the technique of Patent Document 2 is applied to a content playback device, there is a problem that a slide will conflict with a content list scroll process in a content list display screen.

### Means for Solving the Problem

The invention provides a content playback device capable of playing a content a number of times, including: an input means which receives a user's operation; a repetition number deciding means which decides the number of plays based on a locus of contact operation received by the input means; and a playback means which plays the content based on the number of times which is decided by the repetition number deciding means.

Therefore, even if the button for setting a repetition number is not equipped, a user can set the repetition number of a predetermined content easily and definitely by gestures.

In the content playback device, the locus of the contact operation starting from a first coordinate point ends through the first coordinate point.

Therefore, a user can cancel an operation easily during the operation by ending not through the first coordinate point.

The content playback device further includes: a detection range managing means which specifies a first range where the number of plays can be decided, and the first coordinate point is contained within the first range.

Therefore, when a user performs a repetition setting, a wrong operation which starts other functions can be prevented by inhibiting operations other than the repetition setting based on the position which the user contacts first.

In the content playback device, the repetition number deciding means determines the number of plays by measuring the number of passing which is the number of times the locus passes the first coordinate point during a time period from a start to an end of the contact operation.

Therefore, the number of times can be definitely detected regardless of the locus from the start of a gesture to the end of the gesture.

In the content playback device, the playback means plays the content (the number of passing−1) times.

Therefore, the content can be played only the number of times the first coordinate point is passed after the user gesture in which the first coordinate point is contacted first.

The content playback device further includes: a line segment analyzing means which analyzes the number of line segments in the locus, and the repetition number deciding means outputs, to the playback means, the number of line segments analyzed by the line segment analyzing means as the number of plays.

Therefore, the number of times can be definitely detected by using a figure that the user is familiar with.

In the content playback device, the detection range managing means specifies a second range where the number of plays can be subtracted, and when the locus of the contact operation starts from a second coordinate point and ends through the second coordinate point and when the second coordinate point is contained within the second range, the repetition number deciding means determines a repetition subtraction number based on the locus.

Therefore, the repetition number set to a content corresponding to a predetermined coordinate point can be subtracted, and it is possible for a user to freely add or subtract the repetition number.

The content playback device further includes: a control unit which manages repetition setting history, and the detection range managing means changes the detection range based on the repetition setting history.

Therefore, it is possible to provide an operation range which is suitable for a user's preference in accordance with actual operating conditions, and improve operability at the time of setting repetition numbers.

In the content playback device, the detection range managing means expands the detection range, when the number of repetition settings in the repetition setting history becomes more than a predetermined number of times.

Therefore, the repetition setting detection range of the content to which the repetition setting is frequently performed can be expanded, and the operability at the time of setting repetition numbers can be improved.

Further, the invention provides a content playback method capable of playing a content a number of times by using a touchscreen, including: an input step of receiving a user's operation; a repetition number deciding step of deciding the number of plays based on a locus of contact operation received in the input step; and a step of playing the content based on the number of times which is decided in the repetition number deciding step.

Therefore, even if the button for setting a repetition number is not equipped, a user can set the repetition number of a predetermined content easily and definitely by gestures.

Further, the invention provides a content playback program capable of playing a content a number of times, and causes a computer provided with a touchscreen to execute: an input step of receiving a user's operation; a repetition number deciding step of deciding the number of plays based on a locus of contact operation received in the input step; and a step of playing the content based on the number of times which is decided in the repetition number deciding step.

Therefore, even if the button for setting a repetition number is not equipped, a user can set the repetition number of a predetermined content easily and definitely by gestures.

### Advantages of the Invention

According to the content playback device, the content playback method, and the content playback program of the invention, the repetition number of a predetermined content can be set easily and definitely by user gestures.

### BRIEF DESCRIPTION OF THE DRAWINGS

FIG. 1 is a schematic block diagram of a content playback device 100 in an embodiment 1 of the invention.

FIG. 2 is an illustrative figure which shows a correspondence of gestures and the repetition number setting of a predetermined content in the embodiment 1 of the invention, in which, FIG. 2(a) is a figure which shows that a predetermined position (for example, a coordinate point P1) of a musical composition title B is touched, FIG. 2(b) is a figure which shows that the finger is made to slide and pass the coordinate point P1 3 times and FIG. 2(c) is a figure which shows that the slide operation is released.

FIG. 3 is an illustrative figure which shows a correspondence of gestures and the repetition number setting of a plurality of contents in the embodiment 1 of the invention, in which, FIG. 3(a) is a figure which shows that the repetition number of a musical composition of the title B is set as 3, FIG. 3(b) is a figure which shows that the repetition number of a musical composition of a title D is set as 2, and FIG. 3(c) is a figure which shows that the slide operation is released.

FIG. 4 is an illustrative figure which shows a correspondence of gestures and the repetition number subtracting of a predetermined content in the embodiment 1 of the invention, in which FIG. 4(a) is a figure which shows that the repetition number of the musical composition of the title B is set as 3, FIG. 4(b) is a figure which shows that a coordinate point P3 is touched, FIG. 4(c) is a figure which shows that the finger slides in arbitrary directions, and FIG. 4(d) is a figure which shows that the slide operation is released.

FIG. 5 is a flow chart which explains operations of the content playback device 100 in the embodiment 1 of the invention.

FIG. 6 is an illustrative figure which shows a correspondence of gestures and the repetition number setting in an embodiment 2 of the invention, in which, FIG. 6(a) is a figure which shows that a predetermined position (for example, a coordinate point P1′) of the musical composition title B is touched, FIG. 6(b) is a figure which shows that the touching finger slides in arbitrary directions, and FIG. 6(c) is a figure which shows that the slide operation is released.

FIG. 7 is a flow chart which explains operations of the content playback device 100 in the embodiment 2 of the invention.

FIG. 8 is a flow chart which explains operations of the content playback device 100 in an embodiment 3 of the invention.

FIG. 9 is an illustrative figure which shows a correspondence of touch positions and repetition setting detection ranges in the embodiment 3 of the invention, in which, FIG. 9(a) is a figure which shows that a predetermined position (for example, a coordinate point R1) of the musical composition title B is touched, FIG. 9(b) is an illustrative figure which shows a default repetition setting detection range E1, and FIG. 9(c) is an illustrative figure which shows a repetition setting detection range E2 in which only the part of a range E3 is expanded.

### MODE FOR CARRYING OUT THE INVENTION

Next, embodiments of the invention are described with reference to the figures. The present invention can also be represented as a “program” that makes a device such as a content playback device, or a computer which is the device, to operate. Further, the present invention can also be represented as a “method” which includes steps which are performed by a content playback device 100. That is, the present invention can be represented as any one of the device, the method, and the program.

In the embodiments of the invention, the following three contact operations are defined as a user's gestures.

(1) “Touch” is defined as an operation that a finger contacts an arbitrary position on a touchscreen.

(2) “Release” is defined as an operation that a finger which contacts a touchscreen leaves from the touchscreen.

(3) “Slide” is defined as an operation that a finger moves from an arbitrary position (start point) on a touchscreen to another position (end point) while contacting the touchscreen. Even if a moving finger stops for a period of time, the operation is considered as one slide until the finger releases.

### Embodiment 1

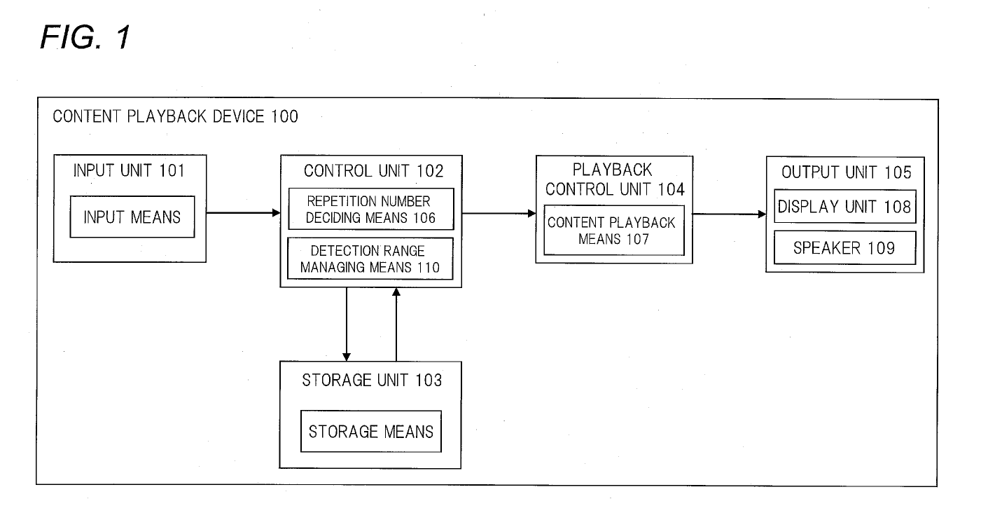

FIG. 1 is a schematic block diagram of the content playback device 100 in the embodiment 1.

The content playback device in the embodiment 1 of the invention is provided with an input unit 101, a control unit 102, a storage unit 103, a playback control unit 104, and an output unit 105, as shown in FIG. 1.

The input unit 101 which is an input means includes a device for inputting coordinates such as a touchscreen or a touch pad, and receives gestures of a user, such as contact operations.

The control unit 102 has a repetition number deciding means 106 and a detection range managing means 110 which is described later, uses contents stored in the storage unit 103, and outputs required information to the playback control unit 104. The repetition number deciding means 106 generates a locus from a contact operation which is input from the input unit 101, and determines a repetition number which is the number of plays based on the number of passing, the number of line segments or the like which are contained in the locus. The detection range managing means 110 specifies an operation range where operations of setting or subtracting repetition numbers on the content are possible, based on range information which is stored in the storage unit 103 or a user's gestures which are output from the input unit 101.

The storage unit 103 includes a nonvolatile or volatile storage device such as a memory card, and stores information required for the control unit 102 to control, such as contents, predetermined coordinate positions, and repetition numbers.

The playback control unit 104 has a playback means 107, and outputs the playback information of the contents to the output unit 105. The playback means 107 plays the contents based on a signal from the control unit 102. For example, the contents are played based on the repetition number determined by the repetition number deciding means.

The output unit 105 has a display unit 108 and a speaker 109. The display unit 108 includes organic electroluminescence, liquid crystal display elements and the like, and displays the playback status and the repetition number of the contents in accordance with directions from the playback control unit 104. The speaker 109 outputs sounds.

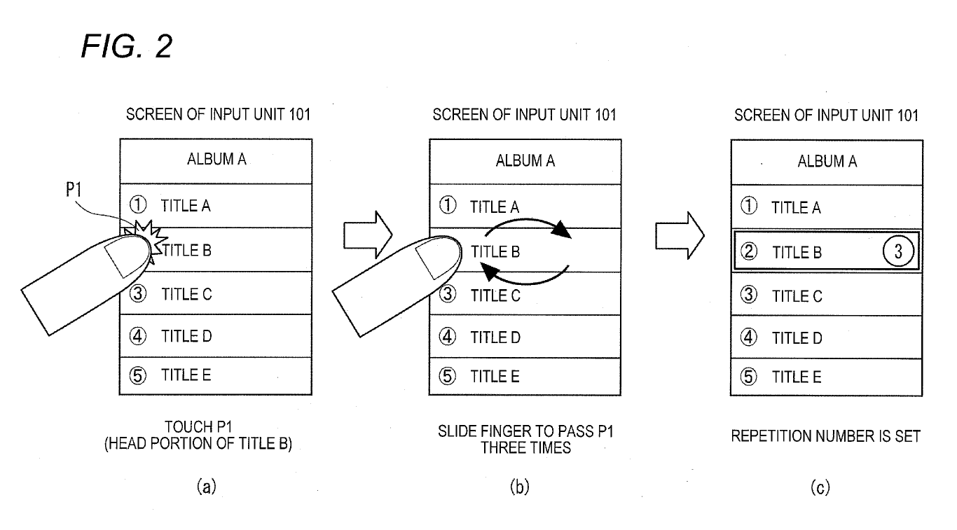

The repetition number deciding means 106 is explained with reference to FIG. 2. FIG. 2 is an illustrative figure which shows a correspondence of gestures and the repetition number setting of a predetermined content in the embodiment 1.

As shown in FIG. 2(a), a user touches a predetermined position (for example, a coordinate point P1 at the head portion) of the musical composition title B on a screen of the input unit 101. FIG. 2(a) is a figure which shows that the predetermined position (for example, the coordinate point P1) of the musical composition title B is touched.

Next, as shown in FIG. 2(b), the user makes the touching finger slide in arbitrary directions. Here, the number of times the coordinate point P1 is passed during the slide is measured, and stored in the storage unit 103. For example, a slide is made by assuming the coordinate point P1 as a starting point and drawing circles, and the locus of the slide passes the coordinate point P1 3 times. FIG. 2(b) is a figure which shows that the finger is made to slide and pass the coordinate point P1 3 times.

Next, when the user releases the sliding operation, as shown in FIG. 2(c), the measured number of times the coordinate point P1 is passed is set as the repetition number of the content corresponding to the coordinate point P1, and is displayed on the display 108. FIG. 2(c) is a figure which shows that the slide operation is released. For example, when the number of times the coordinate point P1 is passed is 3, the musical composition which has the title B corresponding to the coordinate point P1 is set to repeat 3 times, and “3” is displayed as number information at the right end of the title B.

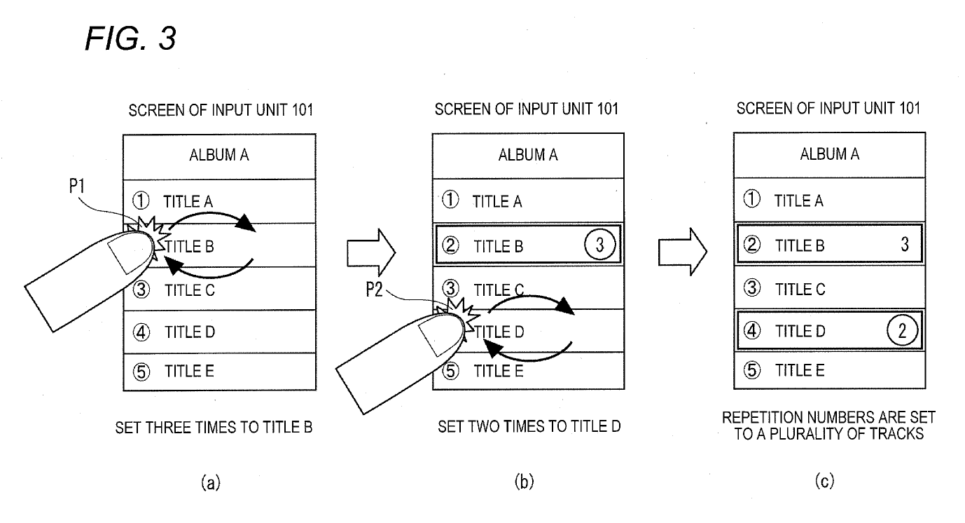

Next, with reference to FIG. 3, the setting of repetition numbers of a plurality of contents performed by the repetition number deciding means 106 is explained. FIG. 3 is an illustrative figure which shows a correspondence of gestures and the repetition number setting of a plurality of contents in the embodiment 1.

As shown in FIG. 3(a), a repetition number of the musical composition title B is set. Since the process is the same as that in FIG. 2, the explanation is omitted. FIG. 3(a) is a figure which shows that the repetition number of the musical composition of the title B is set as 3.

Next, as shown in FIG. 3(b), the user touches a position (for example, a coordinate point P2 at the head portion) of the musical composition title D on the screen of the input unit 101, and makes the touching finger slide in arbitrary directions. Here, the number of times the coordinate point P2 is passed during the slide is measured, and stored in the storage unit 103. FIG. 3(b) is a figure which shows that the repetition number of the musical composition of the title D is set as 2.

Next, when the user releases the sliding operation, as shown in FIG. 3(c), the measured number of times the coordinate point P2 is passed is set as the repetition number of the musical composition corresponding to the coordinate point P2, and is displayed on the display 108. FIG. 3(c) is a figure which shows that the slide operation is released. For example, when the number of times the coordinate point P2 is passed is 2, the musical composition which has the title D corresponding to the coordinate point P2 is set to repeat 2 times, and “2” is displayed as number information at the right end of the title D. In an album playback screen which is not shown in the figure, when played from the title A, the titles A to E are played in 1 time, 3 times, 1 time, 2 times, and 1 time, respectively.

Thus, repetition numbers can be set individually, easily, and definitely for a plurality of contents, respectively.

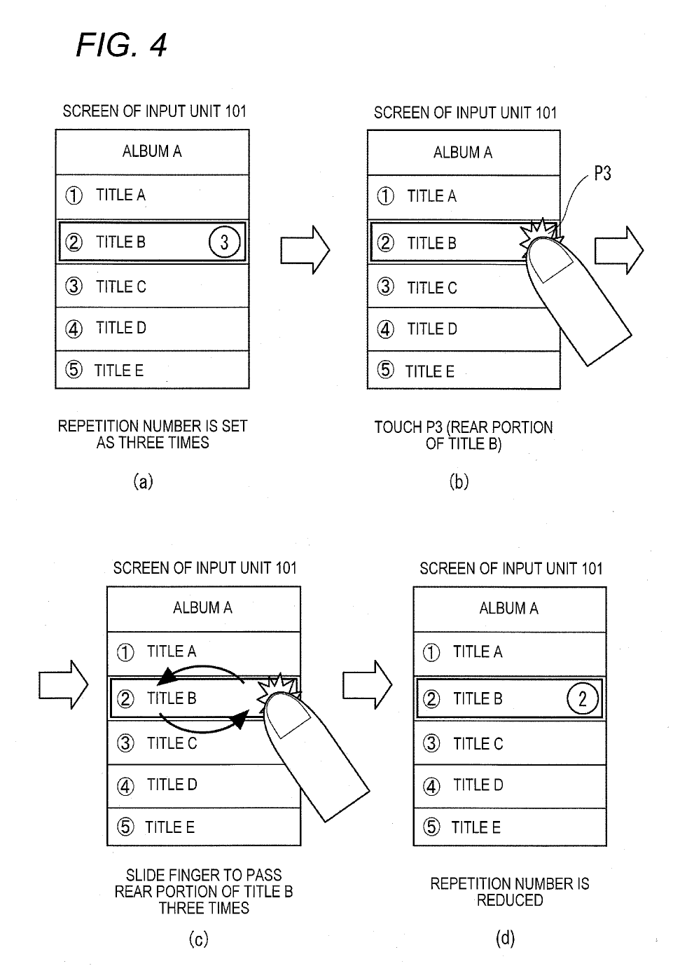

Next, an operation of subtracting the repetition number performed by the repetition number deciding means 106 is explained with reference to FIG. 4. FIG. 4 is an illustrative figure which shows a correspondence of gestures and the repetition number subtracting of a predetermined content in the embodiment 1.

FIG. 4(a) shows that the repetition number is set to 3 times for the musical composition title B as shown in FIG. 2. FIG. 4(a) is a figure which shows that the repetition number of the musical composition of the title B is set as 3.

Next, as shown in FIG. 4(b), the user touches a predetermined position on the screen of the input unit 101 (for example, a coordinate point P3 at the rear portion) other than the coordinate point P1 and P2. Here, it is assumed that the repetition number is displayed at the right end of the musical composition title B. FIG. 4(b) is a figure which shows that the coordinate point P3 is touched.

The touching finger is made to slide in the arbitrary directions, as shown in FIG. 4(c). Here, the number of times the coordinate point P3 is passed during the slide is measured, and stored in the storage unit 103. FIG. 4(c) is a figure which shows that the finger slides in arbitrary directions.

Next, when the user releases at the coordinate point P3, as shown in FIG. 4(d), the measured number of times the coordinate point P3 is passed is subtracted from the repetition number set for the musical composition corresponding to the coordinate point P3, the value after subtraction is newly set as the repetition number, and is displayed on the display 108. FIG. 4(d) is a figure which shows that the slide operation is released.

Thus, it becomes possible to reduce the set repetition numbers easily and definitely for individual or a plurality of contents.

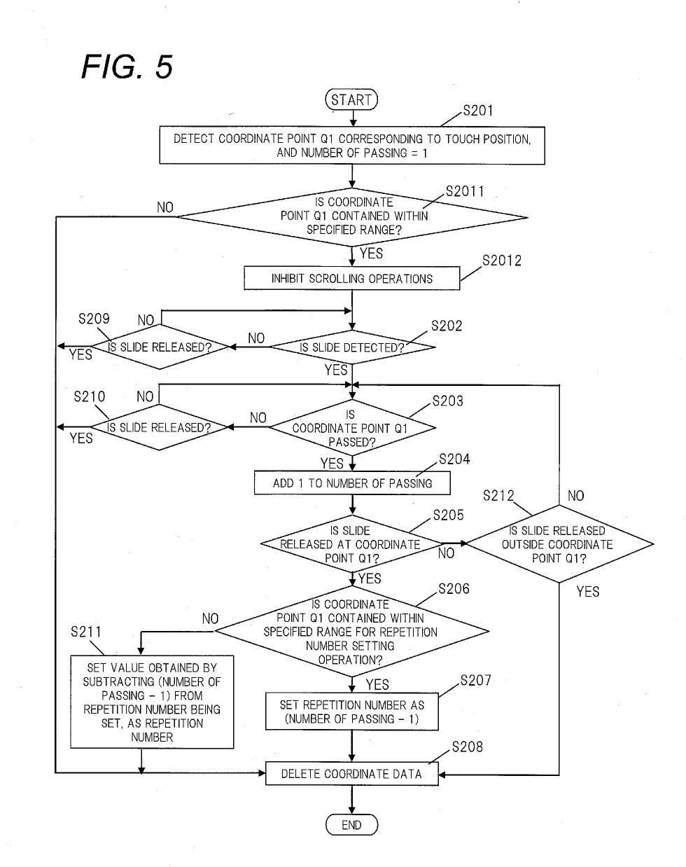

Next, operations of the content playback device 100 of the embodiment 1 are explained by using FIG. 5. FIG. 5 is a flow chart which explains the operations of the content playback device 100 in the embodiment 1.

At Step S201, the input unit 101 detects a coordinate point Q1 corresponding to the touch position of a user's touch operation on the touchscreen. The control unit 102 receives the input from the input unit 101, and stores the coordinate point Q1 in the storage unit 103. Here, the number of times the coordinate point Q1 is passed is assumed as 1. Then, the flow proceeds to Step S2011.

At Step S2011, the control unit 102 receives the input from the input unit 101, and when it is determined that the coordinate point Q1 is in a specified repetition setting range which is determined by the detection range managing means 110, the flow proceeds to Step S2012. For example, the range of the first one fifth or the last one fifth of a musical composition title display area may be specified as the specified range. On the other hand, when it is determined that the coordinate point Q1 is outside the specified repetition setting detection range, the flow proceeds to Step S208.

At Step S2012, the control unit 102 determines that the input from the input unit 101 is a repetition setting operation, and prevents (inhibits) the scroll process of the screen. Then, the flow proceeds to Step S202. Therefore, when a user is to set a repetition number, it becomes possible to prevent unintended operations that make the screen to be scrolled according to gestures.

At Step S202, the control unit 102 receives the input from the input unit 101, and when the user's gesture is determined as a slide operation, the flow proceeds to Step S203. On the other hand, when a slide is not detected and the touch state is kept, the flow proceeds to Step S209.

At Step S209, the control unit 102 receives the input from the input unit 101, and when the user's gesture is determined as a release, the flow proceeds to Step S208. On the other hand, when a release is not detected, the flow proceeds to Step S202.

At Step S203, the repetition number deciding means 106 receives the input from the input unit 101, and when it is determined that the user's gesture passes the coordinate point Q1, the flow proceeds to Step S204. On the other hand, when it is detected that the coordinate point Q1 is not passed, the flow proceeds to Step S210.

At Step S210, the control unit 102 receives the input from the input unit 101, and when a user's gesture is determined as a release, the flow proceeds to Step S208. On the other hand, when a release is not detected, the flow proceeds to Step S203.

At Step S204, the repetition number deciding means 106 adds 1 to the number of times the coordinate point Q1 is passed which is stored in the storage unit 103, and stores in the storage unit 103. Then, the flow proceeds to Step S205. The processes performed at Step S207 or Step S211 described later may be performed here, and the repetition number may be updated each time the coordinate point Q1 is passed and may be displayed on the display 108.

At Step S205, the repetition number deciding means 106 receives the input from the input unit 101, and when the user's gesture is determined as a release at the coordinate point Q1, the flow proceeds to Step S206. On the other hand, when a release is not detected at the coordinate point Q1, the flow proceeds to Step S212.

At Step S212, the control unit 102 receives the input from the input unit 101, and when the user's gesture is determined as a release in positions other than the coordinate point Q1, the flow proceeds to Step S208. On the other hand, when a release is not detected, the flow proceeds to Step S203.

At Step S206, when the repetition number deciding means 106 determines that the coordinate point Q1 is inside the detection range of a repetition number setting operation, changes to Step S207. On the other hand, when it is determined that the coordinate point Q1 is inside the detection range of a repetition number subtraction operation, the flow proceeds to Step S211. For example, the rear portion of a musical composition title or the display portion of the repetition number which is not the detection range of a repetition number setting operation may be specified as the detection range of a repetition number subtraction operation.

At Step S211, the repetition number deciding means 106 subtracts (the number of passing−1) stored in Step S204 from the repetition number set to the content corresponding to the coordinate point Q1, and newly sets the value after the subtraction as the repetition number. Here, when the value after the subtraction becomes smaller than 0, the repetition number is set as 0, and the repetition setting is canceled. When the repetition number is not set to the content corresponding to the coordinate point Q1, the repetition number is not set.

At Step S207, the repetition number deciding means 106 sets the number of passing stored at Step S204 as the repetition number of the content corresponding to the coordinate point Q1. When the repetition number is already set to the content corresponding to the coordinate point Q1, (the number of passing−1) stored at Step S204 is added to the already set repetition number, and the value after the addition is newly set as the repetition number. The set repetition number may be displayed by the display unit 108 in the display range of the content.

At Step S208, the control unit 102 deletes the data of the coordinate point Q1. In this way, when a user's touch operation is input from the input unit 101 next time, it becomes possible to newly detect a coordinate point Q1 corresponding to the touch position at Step S201.

Although the number of times the coordinate point Q1 is passed is assumed as 1 at Step S201 in the embodiment 1, the number of times may be assumed as 0. Although the added value or the subtracted value at Step S211 or Step S207 are (the number of passing−1), the added value or the subtracted value may be (the number of passing).

As mentioned above, the content playback device 100 in the embodiment 1 detects gestures that a user inputs, and detects the number of times a predetermined coordinate point is passed so that the repetition number of the content corresponding to the predetermined coordinate point can be set. Therefore, it is possible for a user to set repetition numbers easily and definitely.

### Embodiment 2

Since the structure of the content playback device 100 in the embodiment 2 is almost the same as that of FIG. 1, the descriptions of the same portions as those in the embodiment 1 are omitted, and the different portions are mainly described.

The control unit 102 has a line segment analyzing means 111 which is not shown in the figure. The line segment analyzing means 111 analyzes the number of the line segments included in the locus generated by the repetition number deciding means 106, and outputs the number of the line segments to the repetition number deciding means 106.

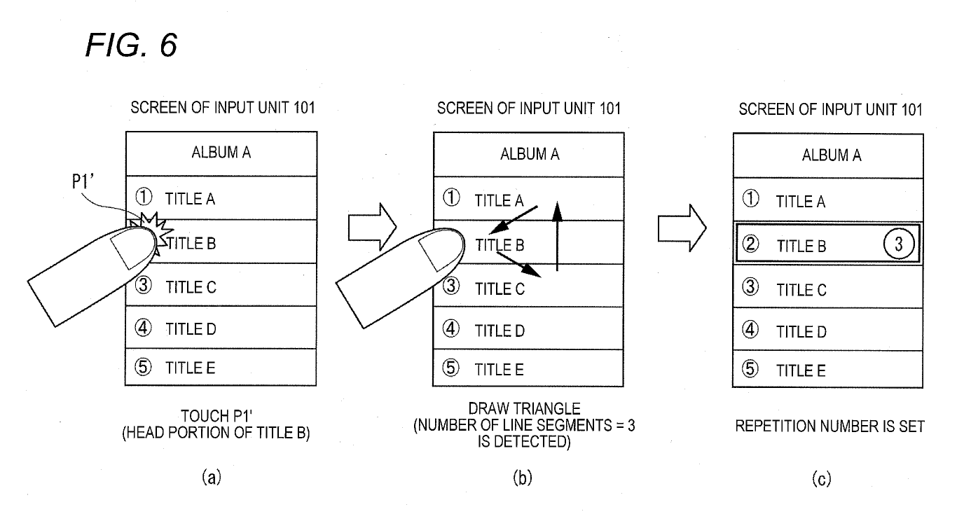

Here, with reference to FIG. 6, the line segment analyzing means 111 and the repetition number deciding means 106 are explained. FIG. 6 is an illustrative figure which shows a correspondence of gestures and the repetition number setting of a predetermined content in the embodiment 2.

As shown in FIG. 6(a), a user touches a predetermined position (for example, a coordinate point P1′ at the head portion) of the musical composition title B on the screen of the input unit 101. FIG. 6(a) is a figure which shows that the predetermined position (for example, the coordinate point P1′) of the musical composition title B is touched.

Next, as shown in FIG. 6(b), the user makes the touching finger slide in arbitrary directions. FIG. 6(b) is a figure which shows that the touching finger slides in arbitrary directions. The repetition number deciding means 106 measures the number of line segments drawn during the slide, and stores the number in the storage unit 103. For example, it is assumed to slide so that a triangle is drawn by using the coordinate point P1′ as a starting point.

Next, when the user releases the sliding operation, as shown in FIG. 6(c), the measured number of line segments is set as the repetition number of the content corresponding to the coordinate point P1′, and is displayed on the display 108. FIG. 6(c) is a figure which shows that the slide operation is released. For example, when a slide is made so that the triangle is drawn, the musical composition which has the title B corresponding to the coordinate point P1′ is set to repeat 3 times, and “3” is displayed as number information at the right end of the title B. Here, not only when a shape is drawn, but also when a slide and a stop are repeated, the number of line segments is counted.

Since the correspondence of gestures and the repetition number setting of a plurality of contents and the repetition number subtraction means in the embodiment 2 are the same as what is described with reference to FIG. 3 except that the number of times the coordinate point P2 is passed is replaced with the number of the drawn line segments, the descriptions are omitted. The processes are performed by the line segment analyzing means 111 and the repetition number deciding means 106.

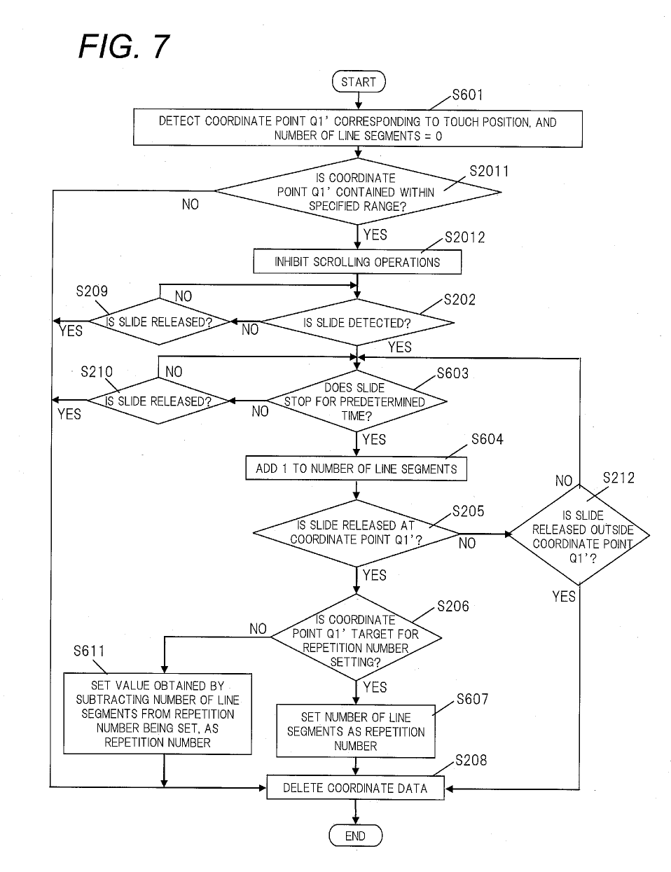

Next, operations of the content playback device 100 of the embodiment 2 are explained using FIG. 7. The same processes as those in FIG. 5 in the embodiment 1 are given the same numbers, and the explanations are also omitted. FIG. 7 is a flow chart which explains the operations of the content playback device 100 in the embodiment 2.

At Step S601, the input unit 101 detects a coordinate point Q1′ corresponding to the touch position of a user's touch operation on the touchscreen. The control unit 102 receives the input from the input unit 101, and stores the coordinate point Q1′ in the storage unit 103. Here, the number of drawn line segments is assumed as 0. Then, the flow proceeds to Step S2011.

At Step S603, the repetition number deciding means 106 receives the input from the input unit 101, and when it is determined from the analysis result of the line segment analyzing means 111 that the user's gesture stops for a predetermined time, the flow proceeds to Step S604. Here, the position where the gesture stops for the predetermined time means the end of a line segment drawn while the user slides. The line segment analyzing means 111 detects drawn line segments by detecting gestures that stop for the predetermined time, and outputs to the repetition number deciding means 106. On the other hand, when the gesture that stops for the predetermined time is not detected, the flow proceeds to Step S210.

At Step S604, the repetition number deciding means 106 adds 1 to the number of drawn line segments which is stored in the storage unit 103, and stores in the storage unit 103. Then, the flow proceeds to Step S605. The processes performed at Step S607 or Step S611 may be performed here, and the repetition number may be updated each time a line segment is drawn and may be displayed on the display 108.

At Step S611, the repetition number deciding means 106 subtracts the number of line segments stored at Step S604 from the repetition number set to the content corresponding to the coordinate point Q1′, and newly sets the value after the subtraction as the repetition number. Here, when the value after the subtraction becomes smaller than 0, the repetition number is set as 0, and the repetition setting is canceled. When the repetition number is not set to the content corresponding to the coordinate point Q1′, the repetition number is not set.

At Step S607, the repetition number deciding means 106 sets the number of line segments stored at Step S604 as the repetition number of the content corresponding to the coordinate point Q1. When the repetition number is already set to the content corresponding to the coordinate point Q1, the number of line segments stored at Step S604 is added to the already set repetition number, and the value after the addition is newly set as the repetition number.

As mentioned above, the content playback device 100 in the embodiment 2 detects gestures that a user inputs, and detects the number of line segments drawn based on the predetermined coordinate point so that the repetition number of the content corresponding to the predetermined coordinate point can be set. Therefore, it is possible for a user to set repetition numbers easily and definitely.

### Embodiment 3

In the embodiments 1 and 2, the repetition number detecting methods are described. In this embodiment, detection ranges of the setting and the subtraction of repetition numbers are explained.

Since the structure of the content playback device 100 in the embodiment 3 is almost the same as that of FIG. 1, the descriptions of the same portions as those in the embodiments 1 and 2 are omitted, and the different portions are mainly described.

The control unit 102 is provided with the detection range managing means 110, and also has a function of managing the setting history of repetition numbers of the contents, and outputting to the storage unit 103. The detection range managing means 110 has a function of changing the detection range where repetition numbers are set or subtracted according to the setting history.

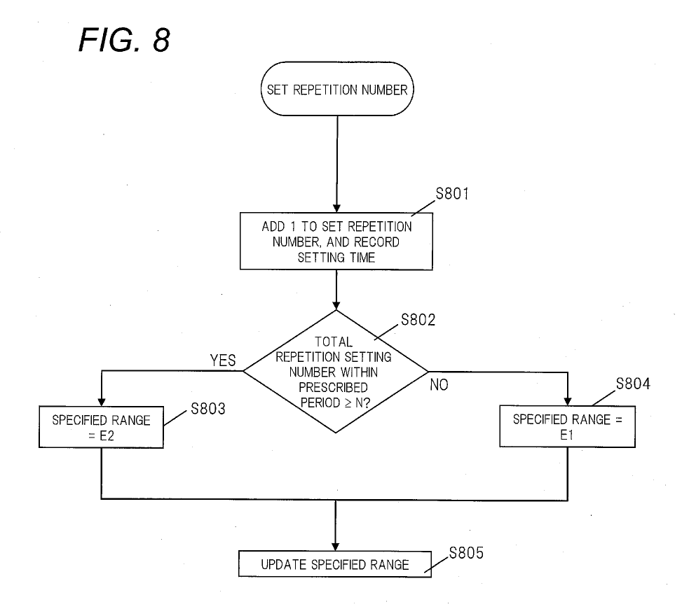

Here, the control unit 102 and the detection range managing means 110 are explained with reference to FIG. 8. FIG. 8 is a flow chart which explains operations of the content playback device 100 in the embodiment 3.

After a repetition number is set, at Step S801, the control unit 102 adds 1 to the set repetition number. For example, when the repetition number setting of a musical composition is performed twice in the past by the method described in the embodiment 1, the repetition setting number is assumed as “2.” The repetition setting number and the setting timing of the repetition number are stored in the storage unit 103. Then, the flow proceeds to Step S802.

At Step S802, the detection range managing means 110 reads out the history information of the repetition setting number or the setting timing from the storage unit 103, and when it is determined that the total repetition setting number within a prescribed period is more than a predetermined number, the flow proceeds to Step S803. On the other hand, when the total repetition number within a prescribed period is less than a predetermined number, the flow proceeds to Step S804. For example, when the repetition setting number to a certain musical composition within one week becomes 5 times or more, the detection range managing means 110 changes the detection range so that the range where the repetition setting of the musical composition is detected is expanded as described later.

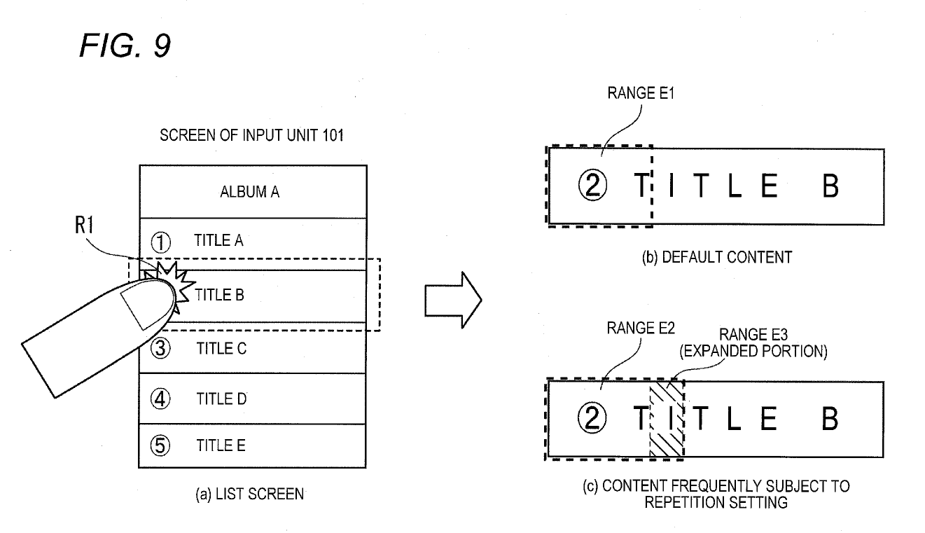

When it is detected that the repetition number is not set in a period of time which is more than a predetermined period of time, the control unit 102 may clear the repetition setting history, and the repetition number may return to “0”. For example, when the repetition setting to a certain musical composition is not performed for one month or more, it is determined that recently the user has little demand for repeatedly listening the musical composition, and in order to further prevent wrong operations, the detection range is returned to the original range. At Step S803, the detection range managing means 110 sets the repetition setting detection range as E2. Then, the flow proceeds to Step S805. The details of the repetition setting detection range are described later by using FIG. 9.

At Step S804, the detection range managing means 110 sets the repetition setting detection range as E1. Then, the flow proceeds to Step S805.

At Step S805, the detection range managing means 110 updates the repetition setting detection range, and outputs to the control unit 102, the storage unit 103, or the repetition number deciding means 106.

Next, a correspondence of touch positions and repetition setting detection ranges is explained with reference to FIG. 9. FIG. 9 is an illustrative figure which shows a correspondence of touch positions and repetition setting detection ranges in the embodiment 3.

FIG. 9(a) is an example of the screen of the input unit 101, and a user's touch position is assumed as R1. FIG. 9(a) is a figure which shows that a predetermined position (for example, the coordinate point P1) of the musical composition title B is touched.

FIG. 9(b) and FIG. 9(c) are figures in which the display area of the musical composition title B of FIG. 9(a) is expanded. As shown in FIG. 9(b), the front portion of a musical composition title (for example, the range of the first one fifth portion of the musical composition title display area) is a repetition setting detection range E1. FIG. 9(b) is an illustrative figure which shows that the repetition setting detection range E1 is the front portion of the musical composition title B. Here, when the position R1 is in the range E1, it is determined that a user's operation is a repetition setting operation.

The range E1 is variable based on a user's repetition setting history stored in the storage unit 103. As shown in FIG. 9(c), for the contents with high repetition setting numbers (for example, a content whose repetition number is set 5 times or more in the last week), the default detection range E1 shown in FIG. 9(b) is expanded only by the portion of the range E3 to the range E2 (for example, the range of the first one fourth portion of the musical composition title display area). FIG. 9(c) is an illustrative figure which shows the repetition setting detection range E2 in which only the portion of the range E3 is expanded. The detection range managing means 110 may provide several different detection ranges according to the repetition setting number.

The above is applicable not only to the detection range where repetition numbers are set but also to the detection range where repetition numbers are subtracted.

As mentioned above, for the content playback device 100 in the embodiment 3, based on the repetition setting number of a content, the repetition setting detection range is variable, and for the musical composition on which repetition setting is frequently performed, the repetition setting detection range is expanded. It is possible to provide an operation range which is suitable for a user's preference in accordance with actual operating conditions, and improve operability at the time of setting repetition numbers.

Although the screen of the input unit 101 is used as a list screen of contents in the invention, the screen of the input unit 101 may be used as a screen of contents that are being played. In this way, it is possible to set the repetition numbers of the contents that are being played without changing to the list screen.

In the invention, when a user is to set to continuously repeat a specific content, for example, a predetermined position (for example, the head portion) of the musical composition title is pressed for a long period of time. In this way, it is possible to set to continuously repeat a musical composition.

In the invention, when a repetition number set to a specific content is to be reset, for example, a predetermined position (for example, the right end) of the musical composition title is pressed for a long period of time. In this way, it is possible to reset the repetition number set to the content.

This application is based on the Japanese patent application (patent application 2010-152626) filed on Jul. 5, 2010, whose contents are incorporated herein by reference.

### INDUSTRIAL APPLICABILITY

The content playback device of the invention is useful for a cellular phone with a touchscreen which has a music playback function, a music playback device with a touchscreen or the like.

### DESCRIPTION OF REFERENCE SIGNS

100 Content Playback Device
101 Input Unit
102 Control Unit
103 Storage Unit
104 Playback Control Unit
105 Output Unit
106 Repetition Number Deciding Means
107 Content Playback Means (Playback Means)
108 Display Unit
109 Speaker
110 Detection Range Managing Means
111 Line Segment Analyzing Means

1. A content playback device capable of playing a content a number of times, comprising:
an input unit which receives a user's operation;
a repetition number deciding unit which decides the number of plays by measuring the number of times contact operation received by the input unit passes a predetermined position during a time period from a start to an end of the contact operation; and
a playback unit which plays the content based on the number of times which is decided by the repetition number deciding unit.

2. The content playback device according to claim 1,
wherein the predetermined position is a first coordinate, and
wherein the locus of the contact operation starting from the first coordinate point ends through the first coordinate point.

3. The content playback device according to claim 2, further comprising:
a detection range managing unit which specifies a first range where the number of plays can be decided,
wherein the first coordinate point is contained within the first range.

4. (canceled)

5. The content playback device according to claim 1,
wherein the playback is unit plays the content (the number of passing−1) times.

6. The content playback device according to claim 1, further comprising:
a line segment analyzing unit which analyzes the number of line segments in a locus of the contact operation,
wherein the repetition number deciding unit outputs, to the playback unit, the number of line segments analyzed by the line segment analyzing unit as the number of plays.

7. The content playback device according to claim 3,
wherein the detection range managing unit specifies a second range where the number of plays can be subtracted, and
wherein when the contact operation starts from a second coordinate point and ends through the second coordinate point and when the second coordinate point is contained within the second range, the repetition number deciding unit determines a repetition subtraction number.

8. The content playback device according to claim 3, further comprising:
a control unit which manages repetition setting history,
wherein the detection range managing unit changes the detection range based on the repetition setting history.

9. The content playback device according to claim 8,
wherein the detection range managing unit expands the detection range, when the number of repetition settings in the repetition setting history becomes more than a predetermined number of times.

10. A content playback method capable of playing a content a number of times by using a touchscreen, comprising:
receiving a user's operation;
deciding the number of plays by measuring the number of times contact operation received in the touchscreen passes a predetermined position of the touch screen during a time period from a start to an end of the contact operation; and
playing the content based on the decided number of plays.

11. A non-transitory computer readable storage medium storing one or more programs, said one or more programs comprising instructions, which when executed by a content playback device with a touchscreen, cause the device to
a user's operation;
decide the number of plays by measuring the number of times contact operation received in the touchscreen passes a predetermined position of the touch screen during a time period from a start to an end of the contact operation; and
the content based on the decided number of plays.

12. The content playback device according to claim 6,
wherein the detection range managing unit specifies a second range where the number of plays can be subtracted, and
wherein when the contact operation starts from a second coordinate point and ends through the second coordinate point and when the second coordinate point is contained within the second range, the repetition number deciding unit determines a repetition subtraction number.
